(19) United States
(12) Patent Application Publication
(10) Pub. No.: US 2024/0314912 A1
(43) Pub. Date: Sep. 19, 2024

(54) CIRCADIAN LIGHTING SYSTEM

(71) Applicant: Circada Ltd., Liverpool (GB)

(72) Inventor: Sam LEWTAS, Liverpool (GB)

(73) Assignee: Circada Ltd., Liverpool (GB)

(21) Appl. No.: 18/571,204

(22) PCT Filed: Jun. 15, 2022
(86) PCT No.: PCT/GB2022/000060

§ 371 Date: Dec. 15, 2023

(30) Foreign Application Priority Data
Jun. 17, 2021 (GB) 2108631.9

(51) Int. Cl. H05B 47/185; H05B 47/16

(52) U.S. Cl. CPC H05B 47/185; H05B 47/16

(57) ABSTRACT

There is described a lighting control system comprising: a data communication module operable to transmit data to a data communication module of a lighting apparatus; one or more microcontrollers configured to: determine an operation pattern or dimmer setting of a light switch based upon received electrical signals; determine a light source output setting for the lighting apparatus based upon the determined operation pattern or dimmer setting of the light switch; and transmit control data based upon the light source output setting using the data communication module to the lighting apparatus.

### TECHNICAL FIELD

This specification relates to a lighting control system, lighting apparatus and combined lighting system.

### BACKGROUND

Smart lighting systems have become increasingly popular. In home environments, such systems are typically controlled using an application on a user device such as a smartphone. Such a control system may not be suitable for larger scale environments, for example in hospitals, schools, offices and other public and commercial buildings where there may be many people using the building over the course of a day. In addition, for larger scale installations, additional networking devices such as wireless bridges may be required. In some instances, a specialised bespoke lighting system may be built and designed which may be costly and difficult to install in existing buildings.

Tailoring artificial lighting levels and consistency in the environment according to the time of day is increasingly being recognised as desirable in national and international lighting guidelines and wellness standards. This is due to the growing understanding of lighting's acute and chronic impact on our mood and health. Research regarding circadian misalignment and social jetlag (the difference between the solar and ‘societal’ clock of which artificial lighting is a part) have suggested that artificial lighting without considering our biological rhythms could have a negative effect to the user.

Current approaches to circadian lighting are typically used with existing methods and protocols of lighting networks. Installation therefore requires with wired systems the addition of extra networking equipment and wiring such as servers, gateways, communication buses, etc. In wired systems, this requires extra wiring for network busses in buildings which adds to the cost and complexity of install, particularly in instances of retrofit. With wireless systems signal considerations may create further challenges to install requiring further equipment (such as signal boosters) and/or with limitations with signal transmissibility through obstacles. Additionally, complexity is incurred in the grouping and programming of units requiring substantial engineer time during the install process. As a further consideration, there is limited bandwidth available for wireless transmissions and demand for that bandwidth is set to increase with more wireless technologies being deployed in buildings.

Such circadian consideration is seen typically as part of a ‘smart’ lighting infrastructure, which is often the primary focus of known systems over and above health gains to be realised in circadian tuning throughout the day. This is further exemplified with these systems typically operating by an application accessed on a dedicated control panel, touch screen interface, remote control, computer or mobile device. These additionally provide burden at the install and commissioning process and are typically less familiar and more challenging to use than the traditional on/off light switch. Such an interface may pose a barrier to use, reducing potential benefits to be obtained from the system.

A circadian lighting system that is easy to install and/or retrofit utilising existing (or requiring simpler) infrastructure, requiring less networking hardware, with a simpler commissioning process, that is more health-oriented with a familiar and intuitive interface moving away from the ‘smart light’ approach would therefore be desirable.

### SUMMARY

Methods and apparatus disclosed herein provide smart lighting systems that can be installed in buildings to make use of existing infrastructure and lighting systems. This reduces the amount of works required, making installation more efficient and less of a technical challenge. Methods and apparatus disclosed also provide for setup and operation of such systems.

According to a first aspect, there is provided a lighting control system comprising a data communication module operable to transmit data to a data communication module of a lighting apparatus. The lighting control system further comprises one or more microcontrollers configured to: determine an operation pattern or dimmer setting of a light switch based upon received electrical signals; determine a light source output setting for the lighting apparatus based upon the determined operation pattern or dimmer setting of the light switch; and transmit control data based upon the light source output setting using the data communication module to the lighting apparatus.

The light source output setting may comprise a brightness setting and/or a colour temperature setting and/or a spectral composition of the light source output. The control data may comprise data indicative of the value of light source output setting. The control data may comprise a synchronisation signal, for example, a clock or timing signal. The lighting control system may further comprise a clock. The clock may be a real-time clock. The control data may be in any suitable format.

The one or more microcontrollers may be further configured to obtain a timing schedule for adjusting the light source output setting. The transmitted control data may be based upon the timing schedule. The timing schedule may be based upon diurnal motion of the sun at a geographical location. That is, the timing schedule may reflect the natural lighting cycle outdoors caused by the movement of the sun during the day at a particular geographical location. The timing schedule may be based upon a user specified schedule. For example, the user specified schedule may offset the solar timing schedule by a period of time. The one or more microcontrollers may be further configured to generate the timing schedule. Alternatively, the timing schedule may be obtained externally, such as from a user device.

Determining the light source output setting may be further based upon configuration data received from a user device. For example, the configuration data may be based upon or comprise the geographic location, the timing schedule and particular values of the light source output setting for different modes of operation. The lighting control system may further comprise a second data communication module for data communication with the user device.

The control data may be transmitted to a plurality of lighting apparatuses. That is, the lighting control system may be used for controlling a plurality of lighting apparatuses.

The control data may be transmitted using a broadcast protocol. The data communication module may be operable to transmit data via power-line communication. That is, data may be transmitted over power cables such as the existing electrical circuitry within a building. Alternatively, the data communication module may be operable to transmit data via wireless networking protocol. The lighting control system may be considered as a transmitter.

The control data may be further based upon ambient outdoor light conditions detected by a light sensor. The lighting control system may further comprise the light sensor.

The lighting control system may be disposed in a single unit or a plurality of units. The lighting control system may be housed within a lamp. That is, the lighting control system may be integrated with a lamp. The lighting control system may control the lamp directly according to the determined light source output setting.

Determining an operation pattern may comprise determining the number of times the light switch has been operated within a time period. That is, the number of times that the light switch has been switched on and off within a particular time period. The operation pattern may also be based upon a duration of time that the switch is held in the on/off positions for.

Determining the dimmer setting of the light switch may comprise determining a position of a dial or slider on the light switch. That is, the light switch may be a dimmer switch. In some instances, the dimmer switch may comprise a rotating dial that also functions as a push button switch. In these instances, an operation pattern similar to the above for a regular on/off type light switch may be determined when the push button switch is operated.

The lighting control system may further comprise an internal power source.

According to a second aspect, there is provided a lighting apparatus comprising an electric light source having a configurable light output. The lighting apparatus further comprises a data communication module operable to receive data from a data communication module of a lighting control system. The lighting apparatus also comprises one or more microcontrollers configured to: determine an operation pattern or dimmer setting of a light switch based upon received electrical signals; receive control data for configuring the light output of the electric light source; determine a mode of operation for the light source based upon the determined operation pattern or dimmer setting of the light switch; and in response to determining a first mode of operation, configuring a light source output setting based upon the received control data.

The one or more microcontrollers may be further configured to: in response to determining a second mode of operation, overriding the light source output setting configured based upon the received control data to a predetermined output setting. That is, in the first mode of operation, the light source output setting follows that of the received control data from the lighting control system. In the second mode of operation, the light source output setting configured using the control data is overridden and follows a preset value. Further modes of operation may be provided in which the control data is fully or partially followed and/or another property of the light source output is altered. For example, in a third mode of operation, the control data may indicate a particular colour temperature which the lighting apparatus follows but the brightness of the light source output may be reduced or otherwise changed. The lighting apparatus may therefore determine when to follow the lighting control system and when to operate independently.

The light source output setting may comprise a brightness setting and/or a colour temperature setting and/or a spectral composition of the light source output. The received control data may comprise data indicative of the value of light source output setting. The received control data may comprise a synchronisation signal. The one or more microcontrollers of the lighting apparatus may be configured to update a clock based upon the received synchronisation signal. The lighting apparatus may further comprise the clock. The clock may be a real-time clock.

Configuring the light source output setting based upon the received control data may be further based upon a timing schedule for adjusting the light source output. The timing schedule may be based upon diurnal motion of the sun at a geographical location. That is, the timing schedule may reflect the natural lighting cycle outdoors caused by the movement of the sun during the day at a particular geographical location. The timing schedule may be based upon a user specified schedule. For example, the user specified schedule may offset the solar timing schedule by a period of time. The one or more microcontrollers may be further configured to obtain the timing schedule, for example, from a memory or storage if previously transmitted to the lighting apparatus. It is possible that the one or more microcontrollers may be further configured to generate the timing schedule itself, for example, if provided with a geographical location.

The data communication module of the lighting apparatus may be operable to receive data via power-line communication. The data communication module of the lighting apparatus may be operable to receive data via wireless networking protocol. The lighting apparatus may be considered as a receiver. The lighting apparatus may be configured to forward the control data to another lighting apparatus. That is, the lighting apparatus may act as a repeater.

The lighting apparatus may be further configured to request control data from a lighting control system. In addition, the lighting apparatus may also transmit data to the lighting control system as necessary, for example, data relating to the status of the lighting apparatus.

Determining an operation pattern may comprise determining the number of times the light switch has been operated within a time period. That is, the number of times that the light switch has been switched on and off within a particular time period. The operation pattern may also be based upon a duration of time that the switch is held in the on/off positions for.

Determining the dimmer setting of the light switch may comprise determining a position of a dial or slider on the light switch. That is, the light switch may be a dimmer switch. In some instances, the dimmer switch may comprise a rotating dial that also functions as a push button switch. In these instances, an operation pattern similar to the above for a regular on/off type light switch may be determined when the push button switch is operated.

The lighting apparatus may further comprise an internal power source.

According to a further aspect, there is provided a lighting system comprising the lighting control system of the first aspect and a lighting apparatus of the second aspect.

The above aspects advantageously provides a smart lighting system that can be operated through a regular light switch without the need for any additional user devices for operation. The operation of the lighting system through a regular light switch is particularly advantageous in indoor environments where many different people may use the rooms in the building, such as in hospitals, schools and offices. Users can simply operate the lighting system using the light switch without the need for each person to have an app installed on a smartphone or for any additional hardware user interfaces to be physically installed such as a bespoke control panel for example. Existing light switches installed in a building can be used which minimises installation requirements. In addition, the configuration of the lighting system can be restricted to a limited set of authorised users that have access to a configuring device whilst the day-to-day operation of the lighting system can be provided to any user via the light switch and the provided operating modes.

Where the lighting control system is integrated with a lamp, the system can be installed easily by replacing a regular lamp (e.g. light bulb or lighting panel) as per normal without requiring any special installation. In addition, where power-line communication is used, data communication can occur over existing electrical infrastructure and no additional networking devices such as wireless access points and bridge devices are required. As such, an existing building can be easily retrofitted with a smart lighting system on a large scale. Lighting apparatus can be added or removed from the system on an ad-hoc basis without the need to reconfigure the system. The system can be considered to be a “plug and play” system.

Where a timing schedule based upon a natural outdoor lighting cycle produced by the movement of the sun over the course of day is used for adjusting a light output setting, the light source can produce lighting conditions that are in tune with the natural circadian rhythm of humans which can aid in a person's wellbeing. This is particularly beneficial when the lighting system is installed in a hospital for example, where having lighting reflective of natural outdoor lighting and in tune with the circadian rhythm can help to improve a patient's general feeling of wellbeing.

According to another aspect, there is provided a light sensor system. The light sensor system comprises a light sensor configured to generate sensor data indicative of a spectral composition of light incident on the sensor. For example, the colour temperature, the intensity or brightness, and/or the wavelength(s) of the incident light. The light sensor system further comprises a transmitter operable to transmit the sensor data via power-line communication.

In this way, the sensor data may be broadcast over existing electrical infrastructure within a building to listening lighting devices. Such lighting devices may be configured to receive the sensor data and adjust their lighting output based upon the sensor data. The lighting output inside a building may reflect the ambient light conditions outdoors. The use of power-line communication allows for existing infrastructure to be used for transmitting the sensor data and allows for easy installation of the light sensor system to existing buildings without the need for additional networking infrastructure or significant wiring for connecting to every lighting controller in a building.

The light sensor system may further comprise one or more microcontrollers configured to process the sensor data prior to transmittal. For example, the sensor data may be converted to a format understood by a receiver such as, a lighting device or lighting control system.

A lighting device may comprise a receiver operable to receive the sensor data transmitted from the light sensor system via power-line communication. The lighting device may further comprise an electric light source having a configurable light output. The lighting device may further comprise one or more microcontrollers configured to receive the sensor data and to adjust a light output setting based upon the received sensor data.

The light sensor system may operate in conjunction with the lighting control system of the first aspect described above. The lighting control system may receive the sensor data from the light sensor system. The lighting control system may generate the control data based upon the received sensor data. The control data may be transmitted from the lighting control system to the lighting apparatus as described above.

Alternatively, the light sensor system may operate directly in conjunction with the lighting apparatus. For example, the light sensor system may comprise one or more microcontrollers configured to generate control data based upon the light sensor data in the format of the control data received by the lighting apparatus. Alternatively, the lighting apparatus may be configured to recognise and directly use the sensor data for configuring the light output setting.

According to an aspect of the invention, there is provided a lighting system comprising: a lighting control system including a first data communication module configured to transmit a synchronisation signal; a plurality of lighting apparatuses including a second data communication module configured to receive the synchronisation signal, wherein at least one of the plurality of lighting apparatuses comprising a lighting microcontroller configured to receive an electrical signal indicating operation of a light switch, and wherein the lighting microcontroller of the at least one of the plurality of lighting apparatuses is further configured to determine a light source output for a driver of an electric light source based on the received synchronisation signal and a timing schedule stored at the lighting apparatus.

Optionally, the first data communication module is configured to transmit the synchronisation signal over an electrical power line.

Optionally, the timing schedule is based upon diurnal motion of the sun at a geographical location.

Optionally, the timing schedule is based upon a user specified schedule.

Optionally, the synchronisation signal is transmitted using a broadcast protocol.

Optionally, the lighting control system includes a control microcontroller configured to receive an electrical signal indicating operation of the light switch and, in response to determining a particular operation pattern of the light switch, the first data communication module is configured to receive configuration data from a user device.

Optionally, the control microcontroller is configured to determine the timing schedule based on the received configuration data.

Optionally, the first data communication module is configured to transmit the timing schedule to the plurality of lighting apparatuses.

Optionally, the first data communication module is configured to transmit the configuration data to the plurality of lighting apparatuses.

Optionally, the second data communication module is configured, in response to the lighting microcontroller determining a particular operation pattern of the light switch, to receive the configuration data or the timing schedule from the first data communication module.

Optionally, the lighting microcontroller is configured to determine the timing schedule based on the configuration data.

Optionally, the lighting system further comprises a light sensor configured to detect ambient outdoor light conditions, and wherein the lighting microcontroller is further configured to determine the light source output based on the detected ambient outdoor light conditions.

Optionally, the lighting apparatus includes the electric light source.

Optionally, the light source output setting comprises a brightness setting and/or a colour temperature setting and/or a spectral composition.

According to an aspect of the invention, there is provided a method of operating a lighting system comprising: transmitting, by a first data communication module of a lighting control system, a synchronisation signal; receiving the synchronisation signal by second data communication module of a plurality of lighting apparatuses; receiving, by a lighting microcontroller of at least one of the plurality of lighting apparatuses, an electrical power signal indicating operation of a light switch; determining, by the lighting microcontroller of the at least one of the plurality of lighting apparatuses, a light source output for a driver of an electric light source based on the received synchronisation signal and a timing schedule stored at the lighting apparatus.

According to an aspect of the invention, there is provided a lighting apparatus comprising: a data communication module configured to receive a synchronisation signal originating from a lighting control system; and a lighting microcontroller configured to receive an electrical signal indicating operation of a light switch, and further configured to determine a light source output for a driver of an electric light source based on the received synchronisation signal and a timing schedule stored at the lighting apparatus.

According to an aspect of the invention, there is provided a method of operating a lighting apparatus comprising: receiving a synchronisation signal by data communication module; receiving, by a lighting microcontroller, an electrical power signal indicating operation of a light switch; determining, by the lighting microcontroller, a light source output for a driver of an electric light source based on the received synchronisation signal and a timing schedule stored at the lighting apparatus.

According to an aspect of the invention, there is provided a lighting control system comprising: a data communication module configured to transmit a synchronisation signal to a plurality of lighting apparatuses of a lighting system, wherein the synchronisation signal is arranged such that a lighting microcontroller of one or more lighting apparatuses may determine a light source output for a driver of an electric light source based on the received synchronisation signal and a timing schedule stored at the lighting apparatus.

According to an aspect of the invention, there is provided a method of operating a lighting control system comprising: transmitting, by a data communication module, a synchronisation signal to a plurality of lighting apparatuses of a lighting system, wherein the synchronisation signal is arranged such that a lighting microcontroller of one or more lighting apparatuses may determine a light source output for a driver of an electric light source based on the received synchronisation signal and a timing schedule stored at the lighting apparatus.

According to an aspect of the invention, there is provided a lighting system comprising: a lighting control system including a first data communication module configured to transmit data over an electrical power line; and a plurality of lighting apparatuses including a second data communication module configured to receive the transmitted data, wherein at least one of the plurality of lighting apparatuses comprises a lighting microcontroller configured to receive an electrical signal indicating operation of a light switch, and wherein the lighting microcontroller of the at least one of the plurality of lighting apparatuses is further configured to determine a light source output for a driver of an electric light source based on the data received from the lighting control system.

Optionally, the data transmitted by the first data communication module includes a synchronisation signal to the plurality of lighting apparatuses over the electrical power line.

Optionally, the lighting microcontroller of the at least one of the plurality of lighting apparatuses is further configured to determine the light source output for the driver of the electric light source based on a timing schedule stored at the lighting apparatus.

Optionally, the timing schedule is based upon diurnal motion of the sun at a geographical location.

Optionally, the timing schedule is based upon a user specified schedule.

Optionally, the data transmitted by the lighting control system over the electrical power line comprises one of the timing schedule or data for the lighting microcontroller to determine the timing schedule.

Optionally, the synchronisation signal is transmitted using a broadcast protocol.

Optionally, the electrical power lines form part of the electrical power system for a lighting system of a building.

Optionally, the lighting control system and/or one or more of the plurality of lighting apparatuses includes a control microcontroller configured to receive an electrical signal indicating operation of the light switch and, in response to determining a particular operation pattern of the light switch, the first data communication module and/or the second data communications module is configured to receive configuration data.

Optionally, the control microcontroller is configured to receive the electrical signal indicating operation of the light switch over an electrical power line.

Optionally, the control microcontroller is configured to determine a timing schedule based on the received configuration data.

Optionally, the first data communication module is configured to transmit the timing schedule to the plurality of lighting apparatuses over the electrical power line.

Optionally, the first data communication module is configured to transmit the configuration data to the plurality of lighting apparatuses over the electrical power line.

Optionally, the second data communication module is configured, in response to the lighting microcontroller determining a particular operation pattern of the light switch, to receive the configuration data or the timing schedule from the first data communication module.

Optionally, the lighting microcontroller is configured to determine the timing schedule based on the configuration data.

Optionally, the lighting system further comprises a light sensor configured to detect ambient outdoor light conditions, and wherein the lighting microcontroller is further configured to determine the light source output based on the detected ambient outdoor light conditions.

Optionally, the lighting apparatus includes the electric light source.

Optionally, the light source output setting comprises a brightness setting and/or a colour temperature setting and/or a spectral composition.

Optionally, the lighting system further comprises a clock, and wherein the lighting microcontroller of the at least one of the plurality of lighting apparatuses is further configured to determine the light source output based on a timing signal from the clock.

Optionally, the at least one of the plurality of lighting apparatuses is further configured to update the clock based on the synchronisation signal received by the second data communication module.

Optionally, the lighting system further comprises an electrical energy store configured to provide electrical power to the clock and/or the second data communication when the at least one of the plurality of lighting apparatuses is switched off.

According to an aspect of the invention, there is provided a method of operating a lighting system comprising: transmitting, by a first data communication module of a lighting control system, data over an electrical power line; receiving the transmitted data by second data communication modules of a plurality of lighting apparatuses; receiving, by a lighting microcontroller of at least one of the plurality of lighting apparatuses, an electrical power signal indicating operation of a light switch; determining, by the lighting microcontroller of the at least one of the plurality of lighting apparatuses, a light source output for a driver of an electric light source based on the data received from the lighting control system.

According to an aspect of the invention, there is provided a lighting apparatus comprising: a data communication module configured to receive data transmitted over an electrical power line and originating from a lighting control system; and a lighting microcontroller configured to receive an electrical signal indicating operation of a light switch, and further configured to determine a light source output for a driver of an electric light source based on the data received from the lighting control system over the electrical power line.

According to an aspect of the invention, there is provided a method of operating a lighting apparatus comprising: receiving data transmitted over an electrical power line and by a data communication module of a lighting control system; receiving, by a lighting microcontroller, an electrical power signal indicating operation of a light switch; determining, by the lighting microcontroller, a light source output for a driver of an electric light source based on the data received from the lighting control system over the electrical power line.

According to an aspect of the invention, there is provided a lighting control system comprising: a data communication module configured to transmit data to a plurality of lighting apparatuses of a lighting system over an electrical power line, wherein the transmitted data is arranged such that a lighting microcontroller of one or more lighting apparatuses may determine a light source output for a driver of an electric light source based on the received data.

According to an aspect of the invention, there is provided a method of operating a lighting control system comprising: transmitting, by a data communication module, data to a plurality of lighting apparatuses of a lighting system over an electrical power line, wherein the transmitted data is arranged such that a lighting microcontroller of one or more lighting apparatuses may determine a light source output for a driver of an electric light source based on the received data.

It will be appreciated that aspects may be combined and that features described in the context of one aspect may be combined with features described in the context of another aspect.

It will be appreciated that aspects of the invention can be implemented in any convenient form. For example, the invention may be implemented by appropriate computer programs which may be carried on appropriate carrier media which may be tangible carrier media (e.g. disks) or intangible carrier media (e.g. communications signals). Aspects of the invention may also be implemented using suitable apparatus which may take the form of programmable computers running computer programs arranged to implement the invention.

### BRIEF DESCRIPTION OF THE FIGURES

Embodiments of the invention will now be described, by way of example, with reference to the accompanying drawings, in which:

FIG. 1 is a schematic illustration of an exemplary lighting system;

FIGS. 2A and 2B are schematic illustrations of electrical signals corresponding to particular modes of operation;

FIG. 3 is a flowchart showing exemplary processing carried out by a lighting control system;

FIG. 4 is a flowchart showing exemplary processing carried out by a lighting apparatus;

FIG. 5 is a flowchart showing exemplary processing carried out by for configuring the lighting system;

FIG. 6 is a schematic illustration of light sensor system.

### DETAILED DESCRIPTION

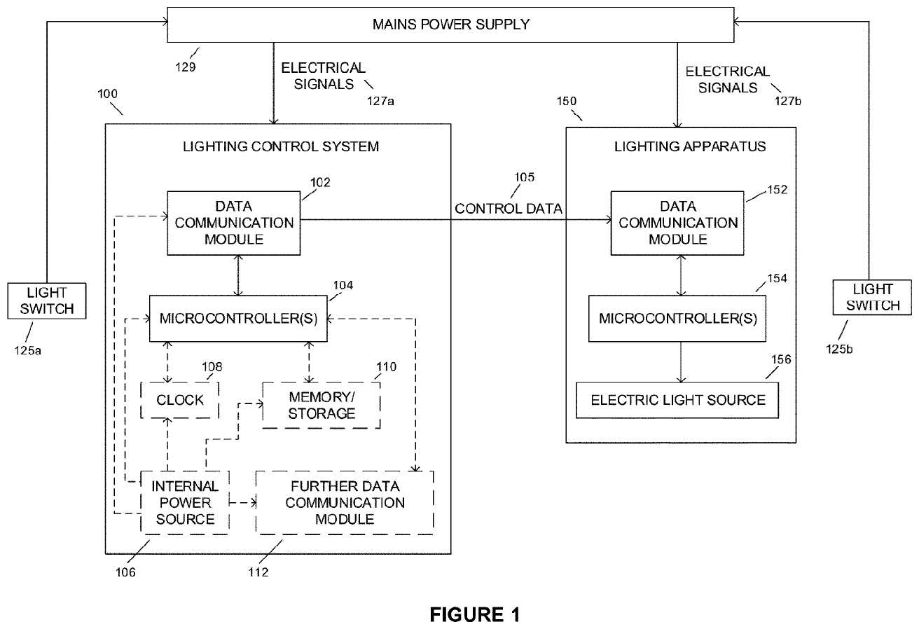

Referring now to FIG. 1, an exemplary lighting system comprising a lighting control system 100 and a lighting apparatus 150 is shown. Whilst FIG. 1 depicts a single lighting apparatus 150, it will be appreciated the lighting system may comprise any number of light apparatuses 150.

The lighting control system 100 comprises a first data communication module 102. The lighting apparatus 150 comprises a second data communication module 152. The data communication module 102 of the lighting control system 100 is operable to transmit data to the data communication module 152 of the lighting apparatus 150. As such, the data communication module 152 of the lighting apparatus 150 is operable to receive data from the data communication module 102 of the lighting control system 100. The data communicated between the lighting control system 100 and the lighting apparatus 150 is described in more detail below.

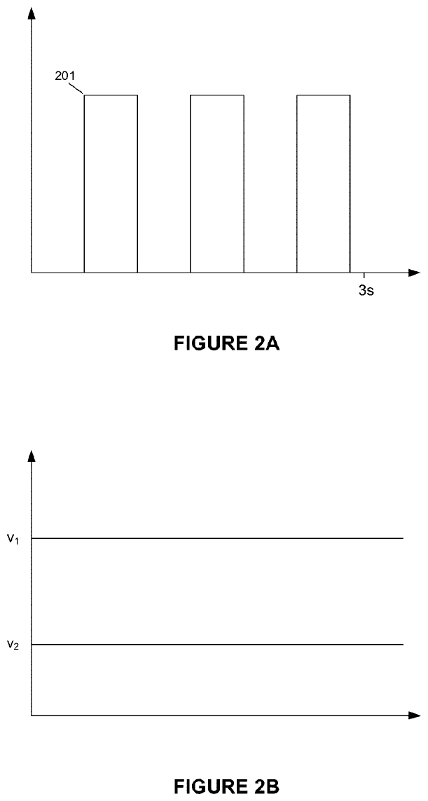

The lighting control system 100 further comprises one or more microcontrollers 104 (e.g. a control microcontroller). The one or more microcontrollers 104 are configured to determine an operation pattern of a light switch 125a based upon received electrical signals 127a. The light switch 125a may be an on/off light switch, a dimmer control or any other type of controller for a light. The operation pattern may include a sequence of a plurality of operations of the light switch 125a within a particular time period. For example, the one or more microcontrollers 104 may be configured to determine the number of times the light switch 125a has been operated within the particular time period. In another example, the one or more microcontrollers 104 may be configured to determine a position of a dial on the light switch 125a (if the light switch 125a is a dimmer switch) or a sequence of a plurality of positions of the dial and/or an on/off switching within the particular time period. The received electrical signals 127a for carrying out the determination of the operation pattern or dimmer setting may be provided via the mains power supply 129. Further details regarding the determination of the operating pattern or dimmer setting are described below with reference to FIGS. 2A and 2B.

The lighting apparatus 150 includes one or more microcontrollers 154 (e.g. a lighting microcontroller and/or a control microcontroller). It is noted that, in alternative arrangements, the one or more microcontrollers 104 of the lighting control system and/or the one or more microcontrollers 154 of the lighting apparatus may be configured to receive electrical signals from a lighting control panel. The lighting control panel may include a number of hard or soft keys that provide control of the lighting system. The lighting control panel may include a touchscreen display allowing a user to operate the lighting system in any desired mode and/or to place the lighting system into a configuration mode.

The one or more microcontrollers 104 of the lighting control system 100 are further configured to determine a light source output setting for the lighting apparatus 150 based upon the determined operation pattern or dimmer setting of the light switch 125a. For example, the light source output setting may comprise a brightness setting and/or a colour temperature setting and/or a spectral composition of the light output. Different operation patterns or dimmer settings may correspond to certain preset values for the light source output setting. In one example, the light source output setting is based upon a timing schedule that dynamically adjusts the value of the light source output setting according to the particular time of day. The adjustment at a particular time of day may be user defined or based on circadian rhythm. This is described in further detail below. The determination of a particular operation pattern or dimmer setting may cause the one or more microcontrollers 104 to determine the light source output setting based upon the timing schedule.

The one or more microcontrollers 104 of the lighting control system 100 are further configured to transmit control data 105 to the lighting apparatus 150 based upon the determined light source output setting using the data communication module 102. The control data 105 may comprise data indicative of the value of the light source output setting, such as the value itself or an adjustment value for modifying the light source output setting to reach a determined value.

Referring now to the lighting apparatus 150, the lighting apparatus 150 comprises an electric light source 156 having a configurable light output. For example, the electric light source 156 may comprise a plurality of LEDs having a configurable brightness, colour temperature and/or spectral composition.

The lighting apparatus 150 also comprises one or more microcontrollers 154 which are configured to determine an operation pattern or dimmer setting of a light switch 125b based upon received electrical signals 127b. The determination may be carried out in a similar manner to that described for the lighting control system 100.

The one or more microcontrollers 154 of the lighting apparatus 150 are further configured to receive control data 105 for configuring the light output of the electric light source 156. The control data 105 is received from the lighting control system 100 as described above.

The one or more microcontrollers 154 of the lighting apparatus 150 are also configured to determine a mode of operation for the light source 156 based upon the determined operation pattern or dimmer setting of the light switch 125b. In response to determining a first mode of operation, a light source output setting is configured based upon the received control data 105. There may optionally be further modes of operation. For example, in response to determining a second mode of operation, where the light source output setting has been configured based upon the received control data 105, the configuration is overridden and reset to a predetermined output setting. Thus, in the first mode of operation, the light source operates according to the received control data 105 from the lighting control system 100 whilst in the (optional) second mode of operation, the light source 156 operates according to a predetermined setting. In the second mode of operation, control data 105 may still be received by the lighting apparatus 150 but the light source output setting remains at the predetermined setting. The received control data 105 may be stored for later use if the mode of operation changes. In another example, a third mode of operation may be provided whereby the light source is configured according to the received control data 105 but the brightness of the light source may be reduced. It will be appreciated that other modes of operation may be provided as deemed appropriate by a person skilled in the art.

In some arrangements, the electric light source 156 may not be included in the lighting apparatus 150. In such arrangements, the electric light source 156 may include a plurality of LEDs and a lighting driver, wherein the lighting driver provides electrical signals to operate the LEDs. The lighting apparatus may include the data communication module 152 and the microcontroller 154. The lighting apparatus 150 may be configured to store control data 105 for use during operation of the lighting system 100. For example, during configuration the lighting apparatus may receive control data 105 specifying one or more modes of operation, e.g. a circadian mode of operation that specifies a particular light output setting based on the time of day. The microcontroller 154 of the lighting apparatus 150 may store that control data 105. When a light switch 125a, 125b is operated, e.g. in a normal manner to turn the lights on, then the microcontroller 154 may determine an output setting (e.g. a brightness setting and/or a colour temperature setting and/or a spectral composition) for the light to be output from the electric light source 156 based on the stored control data 105. The microcontroller 154 of the lighting apparatus 150 may then generate electrical signals that will cause the lighting driver of the electric light source 156 to illuminate the LEDs according to the desired output setting.

In more detail, as noted above, the light source output setting may be adjusted according to a timing schedule. In one example, the light source output setting may be a colour temperature and the colour temperature may be adjusted to reflect the natural lighting cycle in an outdoor environment produced by the movement of the sun over the course of a day. In other words, the timing schedule may be based upon the diurnal motion of the sun at a geographic location, for example such as sunrise and sunset times. Thus, at sunrise for a particular geographic location, the colour temperature may be of a warmer temperature, such as around 2700K. The colour temperature may increase over the course of the morning and in the daytime, the temperature may be of a cooler temperature, such as around 6500K. The colour temperature may then start to decrease back to a warmer colour temperature around sunset. In this way, the light source produces lighting conditions that are in tune with the natural circadian rhythm of humans which can aid in a person's wellbeing.

In another example, the timing schedule may be based upon a user specified schedule. For instance, the user may be a shift worker having to work during night hours. Thus, the normal daytime schedule could be offset such that the lighting output peaks at night rather than during the day. This can help to adjust the circadian rhythm of the user and to help the user feel less fatigued during night hours when are due to be working and to aid the user in falling asleep during the day. In another example, the lighting system may be used in an aircraft and the timing schedule may be based upon the natural lighting cycle at the destination of a flight. This can help passengers with acclimatising to the time zone of the destination.

The one or more microcontrollers 104 of the lighting control system 100 may be further configured to generate the timing schedule. For example, the lighting control system 100 may obtain a geographic location, which may be in the form of a latitude and longitude, and generate a timing schedule for adjusting the light output setting based on the obtained geographic location and a time of day. In some arrangements the timing schedule may include user defined timing, as described above. In further arrangements, the timing schedule may include a hybrid schedule including a circadian timing adjusted as per user or role needs. This may comprise creating a higher ceiling for brightness than base minimum during work or task-specific hours despite changes in colour temperature to provide necessary lighting levels as desired or according to task when outside of the circadian day. The geographic location may be hardcoded into the firmware of the lighting control system 100 as it is unlikely that the lighting control system 100 will be moved after installation and an exact geographic location is not necessarily required. Alternatively, or in addition, the geographic location may be provided by an external device. In this regard, the determination of the light source output setting may be based upon configuration data received from a user device. The configuration data may be based upon or comprise the geographic location or the timing schedule itself or if a timing schedule is not required, particular values of the light source output setting for different modes of operation for example.

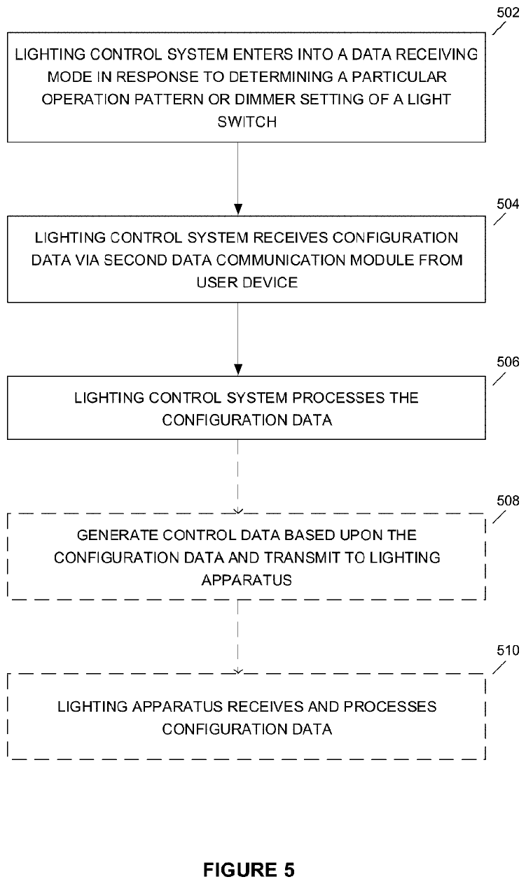

The lighting control system 100 may be configured to enter into a data receiving mode for receiving the configuration data in response to determining a particular operation pattern or dimmer setting of the light switch 125a. The lighting control system 100 may further comprise a further data communication module 112 for data communication with a user device. Thus, the further data communication module 112 may be kept in a sleep state until the particular operation pattern or dimmer setting is determined and the data receiving mode is entered. Once the data transfer between the lighting control system 100 and the user device has completed, the further data communication module 112 may return to the sleep state and the data receiving mode exited. Any data transferred from the user device may be stored a memory/storage 110 of the lighting control system 100. Further details in relation to the process for configuring the lighting control system 100 and the lighting apparatus 150 are described in more detail below with reference to FIG. 5.

The lighting control system 100 may be configured to enter into a standard operation mode in response to determining a particular operation pattern or dimmer setting of the light switch 125a. In the standard operation mode, circadian and/or user defined operation is overridden and the lighting system is operated in a normal on/off fashion.

The lighting controlling system 100 may further comprise a clock 108. The clock 108 may be used to determine a current time and where a timing schedule is used, the clock 108 may be used for generating and transmitting the control data 105 at the appropriate time according to the timing schedule. As noted above, the control data 105 may comprise data indicative of the value of the light source output setting. Alternatively, the control data 105 may comprise a synchronisation signal. For example, the synchronisation signal may be a clock signal. The lighting apparatus 150 may have been provided with the timing schedule for adjusting the light source output setting and the clock signal received from the lighting control system 100 used to adjust the light source output setting according to timing schedule and received clock signal. The lighting apparatus 150 may also comprise a clock. The synchronisation signal may be used to synchronise the clock of the lighting apparatus 150 with the clock of the lighting control system 100. In exemplary arrangements, the lighting apparatus 150 may include an electrical power store, such as a battery or supercapacitor. The electrical power store may be arranged to provide electrical power to the clock while the lighting apparatus 150 is switched off. When the lighting apparatus 150 is switched off, it might not receive electrical power from the mains supply. The electrical power storage may be configured to supply electrical power to the clock whilst it is not received from the mains power supply. This arrangement allows for less frequent transmission of the synchronisation signal from the lighting control system 100 because the clock of the lighting apparatus 150 is able to maintain its own timing. The synchronisation signal may only be required to correct drift errors in the clock of the lighting apparatus 150. In exemplary arrangements, the electrical power store may provide electrical power to the data communications module 152 while the lighting apparatus 150 is switched off and is not receiving electrical power from the mains supply. This allows the data communications module 152 to receive the synchronisation signal during those times.

The control data 105 may be transmitted via power-line communication, that is, data packets may be transmitted over power cables and the existing electrical system within a building. Specifically, the control data 105 may include the timing schedule and/or the clock signal discussed below and these may each be transmitted via power-line communication. Alternatively, the control data 105 may be communicated using a wireless networking protocol such as Wi-Fi, Bluetooth, Zigbee, and cellular communications technology such as 4G/5G. Power-line communication may however be more suitable as certain indoor environments, such as hospitals, may have restrictions on the transmission of wireless signals. In addition, the performance of wireless signals are degraded by physical barriers, such as walls, or through interference from other wireless signals and as such, power-line communication may be preferable.

The control data 105 may be transmitted via a broadcast protocol. In this way, specific network routing is not required, particularly when used in combination with power-line communication. The lighting control system 100 also does not require tracking of the status of specific lighting apparatus 150 and individual lighting apparatus can be added or removed at any time without the need for reconfiguring the control system 100 or the other lighting apparatus 150. This helps to ensure that the system is scalable.

The lighting apparatus 150 may be configured to forward the control data 105 to another lighting apparatus. This may include the data communication module 152 acting as a repeater for the broadcast signal. Alternatively or in addition, this may occur, for example, if a wireless mesh network is used for transmitting the control data 105. The data communication module 152 of the lighting apparatus 150 may also transmit data as well as receive data if necessary.

As discussed above, the lighting control system 100 may further comprise a further data communication module 112 for data communication with a user device. The further data communication module 112 may be configured to communicate data using a different protocol to that of the data communication module 102 for transmitting control data 105. For example, the further data communication module 112 may operate using a wireless protocol whilst the control data 105 may be transmitted via power-line communication as discussed above. Whilst the further data communication module 112 has been described as being distinct from the data communication module 102 for transmitting data to the lighting apparatus 150, in some instances, the data communication module 102 for transmitting data to the lighting apparatus 150 may also be configured to perform the operations of the further data communication module 112 and hence the further data communication module 112 may not be required.

The lighting control system 100 may also comprise an internal power source 106. The internal power source 106 may provide power to components of the lighting control system 100 if the mains power is disconnected. For example, if the lighting control system 100 is on the same circuit as the light switch 125a, it is possible that the lighting control system 100 will not receive mains power until the light switch 125a is turned on. The internal power source 106 may provide power to enable the one or more microcontrollers 104 to detect the operation pattern or dimmer setting of the light switch 125a, to maintain the clock 108 and/or to enable the control data 105 to be continuously transmitted even without a connection to the mains power supply 129. The internal power source 106 may be a coin-cell battery or may be a re-chargeable battery that can be re-charged upon receiving a connection to the mains power supply 129.

The lighting apparatus 150 may also comprise an internal power source, such as for determining an operation pattern or dimmer setting of a light switch 125b. The lighting apparatus 150 may also comprise a clock.

The lighting control system 100 may be disposed in a single unit or may be disposed in a plurality of units in different locations. For example, a first part of the lighting control system 100 may be disposed within the light switch 125a itself which may aid in detecting the operation pattern or dimmer setting of the light switch 125a. The determined operation pattern or dimmer setting may be transmitted to a second part of the lighting control system 100 for determining the light output setting and transmitting the control data 105. The second part may be a control box wired into the lighting circuit or an external wireless router as examples. One or more of the plurality of units may be configured in such a way so as to receive a continuous power feed and an internal power source 106 may not be required for these units.

Where the lighting control system 100 is disposed in a single unit, the lighting control system 100 may be integrated with a lamp. The lighting control system 100 may also control the lamp directly according to the determined light source output setting. It is possible that the functions of the lighting control system 100 and the lighting apparatus 150 are combined together within a lamp. The lamp may then be configured to act as either a controller (lighting control system 100) or a receiver (lighting apparatus 150). Such a configuration may be made by way of a user device as described above for receiving configuration data. Alternatively, a particular operation pattern or dimmer setting of the light switch may be used to provide the setting or a hard switch on the lamp may also be used to configure the setting of controller or receiver.

By providing the lighting control system 100 within a lamp, a smart lighting system can be easily provided simply by installing a lamp as per normal.

The smart lighting system can be operated through a regular light switch without the need for any additional external devices for operation thereby providing a simpler system that is easy to install and operate and requires fewer devices. This is especially the case when used in conjunction with power-line communication which uses the existing infrastructure (power lines) for data communication and does not require external networking devices like wireless access points and bridge devices. Lighting apparatus can be added or removed from the system as and when needed without requiring reconfiguration of the system and thus the provided system is highly scalable. The operation of the lighting system through a regular light switch is particularly advantageous in indoor environments where many different people may use the rooms in the building, such as in hospitals, schools and offices. Users can simply operate the lighting system using the light switch without the need for each person to have an app installed on a smartphone or the need for bespoke user control panels for example. In addition, the configuration of the lighting system can be restricted to a limited set of authorised users that have access to a configuring device whilst the day-to-day operation of the lighting system can be provided to any user via the light switch and the provided operating modes.

As discussed, the lighting apparatus 150 operates in a first mode of operation whereby the light source output setting follows that of the received control data 105. In an optional second mode of operation, the light source output setting is overridden and follows a preset value. The first mode of operation may be a circadian mode following a timing schedule according to a natural lighting cycle as provided to the lighting apparatus 150 by the control data 105. The second mode of operation may be a task lighting mode whereby the light source is returned to a default light output setting. For example, the lighting system may be used in a hospital setting whereby the circadian mode may be useful in helping patients' recovery by providing lighting that reflects natural conditions and their circadian rhythm. In an emergency situation, it is possible that full lighting output is required by medical professionals to provide maximum visibility for treating a patient and thus the second mode of operation provides an override and task lighting mode.

It will be appreciated that further modes of operation may exist. For example, in one further mode of operation, the light source output setting may follow the received control data 105 but the brightness of the light source may be reduced. In another example, the control data 105 may be overridden for a predefined period of time before resuming operation based upon the control data 105. In a further example, there may be a plurality of preset values, such as a plurality of colour values, with further modes of operation each corresponding to one of the plurality of preset values. The further modes of operations may be entered in response to the determination of corresponding operation patterns or dimmer settings of the light switch 125b.

Referring now to FIGS. 2A and 2B, further details with respect to determining an operation pattern or dimmer setting of a light switch will now be described. In a first example, a traditional light switch with on and off positions is assumed. When the light switch 125a is in the off position, the lighting apparatus 150 is disconnected from the mains power supply 129. When the light switch 125b is moved to the on position, the lighting control system 100 is connected to the mains power supply 129. Thus, when a user operates the light switch 125a by moving the switch from the off position to the on position, a step change in the electrical signal 127a received from the mains power supply 129 can be observed.

The operation pattern for determining a particular mode of operation may be determined based upon the number of times the light switch has been operated, i.e. turned on and off, within a particular time period. For example, three operations of the light switch within a period of three seconds may correspond to one particular mode of operation. This may be determined by detecting the number of step changes (either rising or falling or both) in the received electrical signal 127b from the mains power supply 129. In the particular exemplary pattern of three operations within three seconds, an electrical signal 127b may be received as shown in FIG. 2A having three rising/falling step changes. To facilitate such a determination, a clock 108 may be employed to count the three second period. For example, when a first step change 201 is detected, a three second timer may be started and the number of step changes counted until the expiry of the three second timer to determine the operation pattern of the light switch 125b. In another example, the operation pattern may be based upon a duration of time that the switch is held in the on/off positions for. For instance, one pattern may correspond to a short on/off cycle time and another pattern may correspond to a longer on/off cycle time or a pattern may be based upon some combination of short and long cycle times. It will be appreciated that other operation patterns and durations of time may be used as deemed appropriate by a person skilled in the art.

The step change in the received electrical signal 127b may be a change in voltage or current or other appropriate measure as deemed appropriate by a person skilled in the art. The received electrical signal 127b may be converted to a DC signal prior to carrying out the detection of the operation pattern or the received electrical signal 127b may be an AC signal with the detection of step changes taking the alternating cycle of the AC signal into account.

In another example, the light switch may be a dimmer switch. As discussed above, the mode of operation may be determined based upon a dimmer setting. A dimmer switch may have a rotating dial or a slider to provide the dimmer setting. As such, the dimmer setting may be based upon a position of the slider or dial. In one example, adjusting the dimmer switch causes a change in voltage. Therefore, the dimmer setting may be determined based upon the detecting the voltage level of the received electrical signal 127b. As shown in FIG. 2B, a first voltage level v₁ may be detected which may correspond to a determination of the first mode of operation. A second voltage level v₂ may be detected which may correspond to a determination of the second mode of operation.

In another example, a dimmer switch may operate by cutting the rising and/or trailing edge of an AC signal. The dimmer setting may adjust the duration the AC signal is cut-out. The dimmer setting may therefore be determined by analysing the received electrical signal 127b to determine the length of the cut-out.

In some instances, the rotating dial of a dimmer switch may also function as a push button switch. In these instances, the push button switch may be operated according to the provided operation patterns of an on/off type light switch to effect a change in the mode of operation.

Whilst the determination of the operation pattern and dimmer setting has been described in the context of the lighting apparatus 150, it will be appreciated that the above can also be applied for determining the operation pattern and dimmer setting for the lighting control system 100.

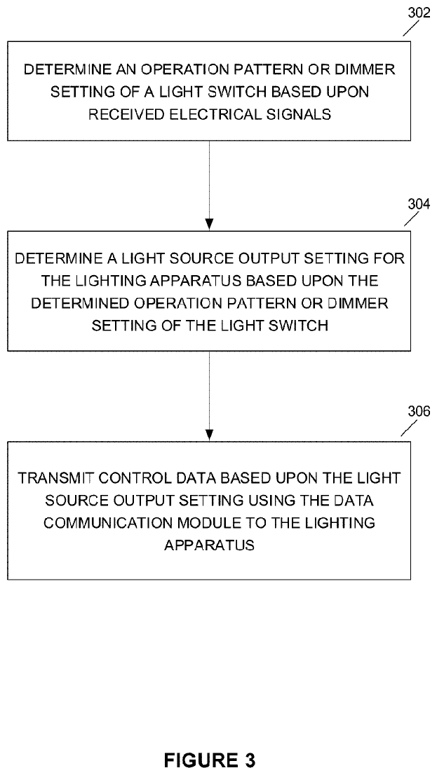

Referring now to FIG. 3, there is shown exemplary processing performed by a lighting control system 100 such as that shown in FIG. 1. At step 302, an operation pattern or dimmer setting of light switch 125a is determined based upon received electrical signals 127a. At step 304, a light source output setting for the lighting apparatus is determined based upon the determined operation pattern or dimmer setting of the light switch 125a at step 302. At step 306, control data 105 is transmitted to a lighting apparatus 150 using a data communication module 102. The control data 105 is based upon the light source output setting determined at step 304. Each of the steps provided in FIG. 3 may be implemented in accordance with that described above with reference to FIGS. 1 and 2.

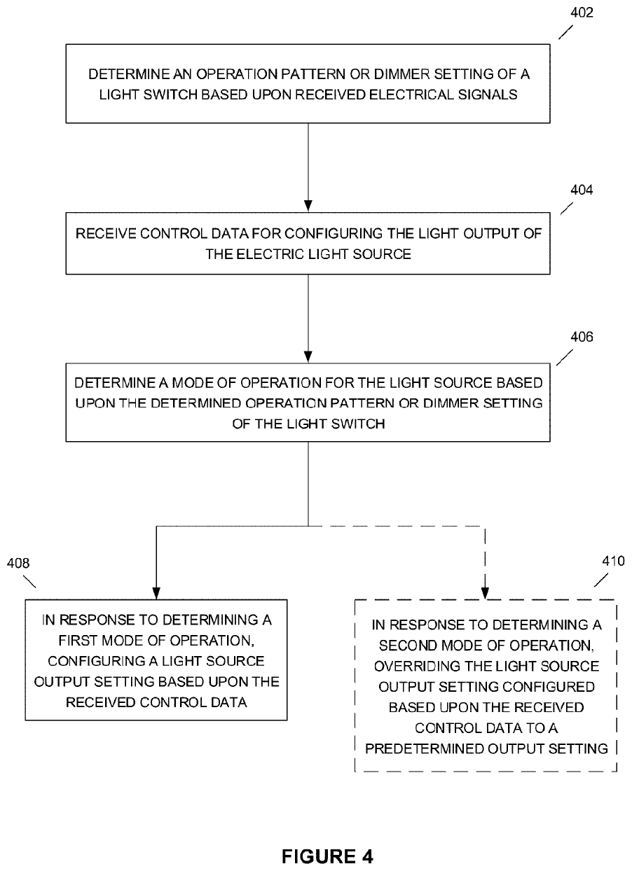

Referring now to FIG. 4, there is shown exemplary processing performed by a lighting apparatus 150 such as that shown in FIG. 1. At step 402, an operation pattern or dimmer setting of a light switch 125b is determined based upon received electrical signals 127b. For example, a user may turn on the lights in a room in the normal way, i.e. by flicking on the light switch, operating a dimmer switch or operating the correct control of a lighting control panel. At step 404, control data 105 for configuring the light output of an electric light source 156 is received. The control data 105 may be a clock signal. For example, the lighting control system may broadcast the clock signal to a plurality of lighting apparatuses 150, such that they are synchronised.

At step 406, the microcontroller 154 may determine a mode of operation for the light source 156 based upon the determined operation pattern or dimmer setting at step 404. For example, the microcontroller 154 may be configured to default to a mode of operation that is based on the timing schedule when the light switch 125a, 125b is operated in a normal way to turn on the lights, and may be configured to operate in a mode that overrides the timing schedule when a specific sequence of light switches or dimmer settings is implemented by the user.

At step 408, in response to determining a first mode of operation, the light source output setting is configured based upon the control data 105 (e.g. the timing signal) received at step 404 and any additional control data 105 (e.g. the timing schedule) stored by the lighting apparatus 150. Optionally, where a second mode of operation is provided, at step 410, in response to determining a second mode of operation, the light source output setting is overridden to a predetermined output setting. This may be the standard setting of operation of the LEDs. Each of the steps provided in FIG. 4 may be implemented in accordance with that described above with reference to FIGS. 1 and 2.

Referring now to FIG. 5, there is shown exemplary processing for configuring a lighting system such as that shown in FIG. 1. At step 502, the lighting control system 100 enters into a data receiving mode in response to determining a particular operation pattern or dimmer setting of a light switch 125a. In the data receiving mode, the lighting control system 100 may activate a further data communication module 112 to begin data communication with a user device such as a smartphone or other appropriate device.

At step 504, the lighting control system 100 receives configuration data via the further data communication module 112 from the user device. The configuration data may be entered by the user using an application installed on the user device. As discussed above, the configuration data may be based upon or comprise a geographic location, a timing schedule, the preset values of the light source output setting, the configuration of other modes of operation and/or any other suitable configuration data.

At step 506, the one or more microcontrollers 104 of the lighting control system 100 processes the configuration data as appropriate. For example, if a geographic location is provided, the one or more microcontrollers 104 may generate a timing schedule for adjusting the light source output setting. Or if a timing schedule is provided, the timing schedule may be stored in a memory/storage 110 for use in generating control data.

The lighting control system 100 may exit the data receiving mode either automatically after completion of processing of the configuration data or after completion of the receipt of the configuration data. Alternatively, the lighting control system 100 may exit the data receiving mode upon receipt of a signal indicating the completion of the configuration operation from the user device or after a timeout when no further data has been received.

The further data communication module 112 may transition to a sleep mode on exiting the data receiving mode.

If the configuration data relates to the lighting apparatus 150, then at step 508, control data may be generated based upon the configuration data and transmitted to the lighting apparatus 150. Accordingly, the lighting apparatus 150 may also be placed in data receiving mode, e.g. by determining the particular operation pattern or dimmer setting of a light switch 125a mentioned above. At step 510, the configuration data is received and processed by the lighting apparatus. For example, if the configuration data comprises a timing schedule or a preset value for the light source output setting, the data may be stored in a memory/storage for use in the first or second mode of operation.

Alternatively, configuration data may be provided directly to the lighting apparatus 150. In this regard, the lighting apparatus 150 may also be operable to enter into a data receiving mode and to receive configuration data in a similar manner to that of the lighting control system 100 described above.

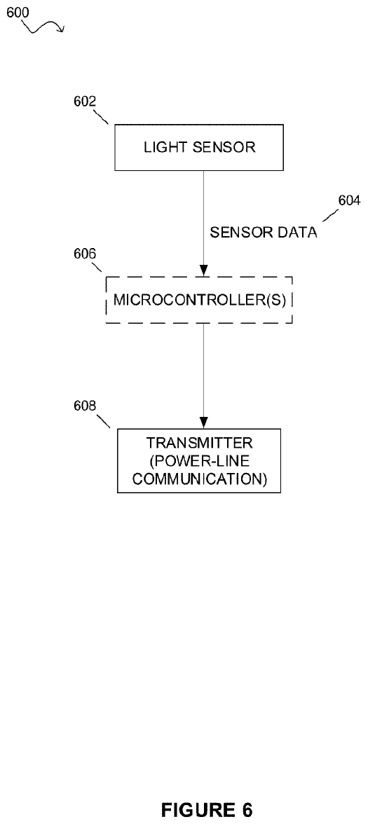

Referring now to FIG. 6, there is shown a light sensor system 600. The light sensor system 600 comprises a light sensor 602 configured to generate sensor data 604 indicative of a spectral composition of light incident on the sensor. For example, the light sensor 602 may be a colour sensor. The sensor data 604 may, for example, be indicative the colour temperature, the intensity or brightness, and/or the wavelength(s) of the incident light. In use, the light sensor 602 is mounted such that ambient light outdoors is incident on the sensor, such as on a rooftop or to an external wall of a building.

The light sensor system 600 further comprises a transmitter 608 which is operable to transmit the sensor data 604 via power-line communication. Thus, the sensor data 604 may be transmitted over existing electrical infrastructure within a building to listening lighting devices. Such lighting devices may be configured to receive the sensor data 604 and adjust their lighting output based upon the sensor data 604. In this way, the lighting output inside a building reflects the ambient light conditions outdoors. The use of power-line communication allows for existing infrastructure to be used for data communication and allows for easy installation of the light sensor system 600 to existing buildings without the need for additional networking infrastructure or significant wiring for connecting to every lighting controller in a building.

The light sensor system 600 may further comprise one or more microcontrollers 606 configured to process the sensor data 604 prior to transmittal. For example, the sensor data 604 may be converted to a format understood by a receiver such as, a lighting device or lighting control system.

The light sensor system 600 may operate in conjunction with the lighting control system 100 of FIG. 1. For example, the lighting control system 100 may receive the sensor data 604 from the light sensor system 600. The lighting control system 100 may generate the control data 105 based upon the received sensor data 604. The control data 105 may be transmitted from the lighting control system 100 to the lighting apparatus 150 as described above.

Alternatively, the light sensor system 600 may operate directly in conjunction with the lighting apparatus 150. For example, the light sensor system 600 may further comprise one or more microcontrollers 606 to generate control data based upon the light sensor data 604 in the format of the control data 105 received by the lighting apparatus 150. Alternatively, the lighting apparatus 150 may be configured to recognise and directly use the sensor data 604 for configuring the light output setting.

Although specific embodiments of the invention have been described above, it will be appreciated that various modifications can be made to the described embodiments without departing from the spirit and scope of the present invention. That is, the described embodiments are to be considered in all respects exemplary and non-limiting. In particular, where a particular form has been described for particular processing, it will be appreciated that such processing may be carried out in any suitable form arranged to provide suitable output data.

1. A lighting system comprising:
a lighting control system including a first data communication module configured to transmit data over an electrical power line; and
a plurality of lighting apparatuses including a second data communication module configured to receive the data,
wherein at least one of the plurality of lighting apparatuses comprises a lighting microcontroller configured to receive an electrical signal indicating operation of a light switch,
and wherein the lighting microcontroller of the at least one of the plurality of lighting apparatuses is further configured to determine a light source output for a driver of an electric light source based on the data received from the lighting control system.

2. The lighting system of claim 1, wherein the data transmitted by the first data communication module includes a synchronisation signal to the plurality of lighting apparatuses over the electrical power line.

3. The lighting system of claim 1, wherein the lighting microcontroller of the at least one of the plurality of lighting apparatuses is further configured to determine the light source output for the driver of the electric light source based on a timing schedule stored at the at least one of the plurality of lighting apparatuses.

4. The lighting system of claim 3, wherein the timing schedule is based upon diurnal motion of a sun at a geographical location.

5. The lighting system of claim 3, wherein the timing schedule is based upon a user specified schedule.

6. The lighting system of claim 3, wherein the data transmitted by the lighting control system over the electrical power line comprises one of the timing schedule or second data for the lighting microcontroller to determine the timing schedule.

7. The lighting system of claim 2, wherein the synchronisation signal is transmitted using a broadcast protocol.

8. The lighting system of claim 1, wherein the electrical power line forms part of the electrical power system for the lighting system of a building.

9. The lighting system of claim 1, wherein at least one of the lighting control system or one or more of the plurality of lighting apparatuses includes a control microcontroller configured to receive an electrical signal indicating operation of the light switch and, in response to determining a particular operation pattern of the light switch, at least one of the first data communication module or the second data communications module is configured to receive configuration data.

10. The lighting system of claim 9, wherein the control microcontroller is configured to receive the electrical signal indicating operation of the light switch over the electrical power line.

11. The lighting system of claim 9, wherein the control microcontroller is configured to determine a timing schedule based on the configuration data.

12. The lighting system of claim 11, wherein the first data communication module is configured to transmit the timing schedule to the plurality of lighting apparatuses over the electrical power line.

13. The lighting system of claim 9, wherein the first data communication module is configured to transmit the configuration data to the plurality of lighting apparatuses over the electrical power line.

14. The lighting system of claim 12, wherein the second data communication module is configured, in response to the lighting microcontroller determining a particular operation pattern of the light switch, to receive the configuration data or the timing schedule from the first data communication module.

15. The lighting system of claim 14, wherein the lighting microcontroller is configured to determine the timing schedule based on the configuration data.

16. The lighting system of claim 1, further comprising a light sensor configured to detect ambient outdoor light conditions, and wherein the lighting microcontroller is further configured to determine the light source output based on the ambient outdoor light conditions.

17. The lighting system of claim 1, wherein the lighting apparatus includes the electric light source.

18. The lighting system of claim 1, wherein the light source output is associated with a setting comprising at least one of a brightness setting, a color temperature setting, or a spectral composition.

19. The lighting system of claim 1, wherein at least one of the plurality of lighting apparatuses comprises a clock, and wherein the lighting microcontroller of the at least one of the plurality of lighting apparatuses is further configured to determine the light source output based on a timing signal from the clock.

20. The lighting system of claim 19, wherein the at least one of the plurality of lighting apparatuses is further configured to update the clock based on a synchronisation signal received by the second data communication module.

21. The lighting system of claim 19, wherein the at least one of the plurality of lighting apparatuses further comprises an electrical energy store configured to provide electrical power to at least one of the clock or the second data communication module when the at least one of the plurality of lighting apparatuses is switched off.

22. A method of operating a lighting system comprising:
transmitting, by a first data communication module of a lighting control system, data over an electrical power line;
receiving the data by second data communication modules of a plurality of lighting apparatuses;
receiving, by a lighting microcontroller of at least one of the plurality of lighting apparatuses, an electrical power signal indicating operation of a light switch; and
determining, by the lighting microcontroller of the at least one of the plurality of lighting apparatuses, a light source output for a driver of an electric light source based on the data received from the lighting control system.

23. (canceled)

24. A lighting apparatus comprising:
a data communication module configured to receive data transmitted over an electrical power line and originating from a lighting control system; and
a lighting microcontroller configured to receive an electrical signal indicating operation of a light switch,
wherein the lighting apparatus is configured to determine a light source output for a driver of an electric light source based on the data received from the lighting control system over the electrical power line.

25. A method of operating a lighting apparatus comprising:
receiving data transmitted over an electrical power line and by a data communication module of a lighting control system;
receiving, by a lighting microcontroller, an electrical power signal indicating operation of a light switch; and
determining, by the lighting microcontroller, a light source output for a driver of an electric light source based on the data received from the lighting control system over the electrical power line.

26. (canceled)

27. A lighting control system comprising:
a data communication module configured to transmit data to a plurality of lighting apparatuses of a lighting system over an electrical power line,
wherein the data is arranged such that a lighting microcontroller of one or more lighting apparatuses is configured to determine a light source output for a driver of an electric light source based on the data.

28. A method of operating a lighting control system comprising:
transmitting, by a data communication module, data to a plurality of lighting apparatuses of a lighting system over an electrical power line,
wherein the data is arranged such that a lighting microcontroller of one or more lighting apparatuses is configured to determine a light source output for a driver of an electric light source based on the data.

29. (canceled)
